(19) United States
(12) Patent Application Publication
(10) Pub. No.: US 2007/0012517 A1
(43) Pub. Date: Jan. 18, 2007

(54) Vehicular fluid drip identification mat

(76) Inventor: Ilia Brouchkov, Ottawa (CA)

Correspondence Address: Stephen B. Salai, Esq.;Harter, Secrest & Emery LLP, 1600 Bausch & Lomb Place, Rochester, NY, 14604-2711, US

(21) Appl. No.: 11/485,407

(22) Filed: Jul. 12, 2006

(30) Foreign Application Priority Data
Jul. 13, 2005 (CA) 2512130

(51) Int. Cl. F16N 31/00

(52) U.S. Cl. 184/106

(57) ABSTRACT

A vehicle fluid drip identification mat for collecting and identifying various fluids from a vehicle is disclosed. The mat is placed underneath the vehicle and dripping fluids are collected. The design of the mat enables the user to identify the location of fluids leakage. The mat design is consisted of illustrated and defined fluid identification sections corresponding to the various vehicle parts. Since each section corresponds to a particular vehicle part, such as engine and transmission, that may potentially be leaking fluid, the user can readily identify which vehicle part of the fluid leakage comes from by simply examining the specific section of the mat that is collecting the leaking fluid. The user can also specify the approximate location of the leak relative to the parked vehicle.

### FIELD OF THE INVENTION

The present invention relates to a fluid drip identification mat for collecting and identifying different types of fluids leaking from a vehicle. A plurality of sections are marked on the mat surface to enable the user to quickly and easily identify the source of fluid leakage and the approximate location of the leak relative to the parked vehicle.

### BACKGROUND OF THE INVENTION

Heretofore, there are numerous prior art mats designed for collecting or absorbing various leaking fluids from vehicles. Some of these mats are mounted on the chassis of the vehicle. Examples of this type of drip identification mat include U.S. Pat. Nos. 5,526,900 and 4,936,418. There are also mats which are placed on the floor of the vehicle-parking area. For example, U.S. Pat. Nos. 6,165,591 and 5,957,241. While these prior art drip identification mats possess certain advantages, none of them are capable of specifying what vehicle fluids are actually leaking, and from which part of the vehicle component, nor providing the approximate location of the leak relative to the parked vehicle

This shortcoming poses a major disadvantage for vehicle users. While it is true that some users are more knowledgeable than others and may be able to identify the type of fluid by examining the leaked fluid, many others may not be so knowledgeable. This inability to identify what fluid had, in fact, leaked from which vehicle part adds to the costs of car repairing. For such an inability will likely cause the service technician to check multiple parts of a vehicle to determine what it is that is leaking, thus rendering car repair more costly. In fact, it is not unusual for a service technician to ask a vehicle's owner information about the approximate location of the leaked fluid in an attempt to pin point the source of leakage.

On the other hand, if a user is equipped with a drip identification mat which can enable him to identify which part of the vehicle the leaks may be coming from, the service technician can then focus on that vehicle part first, thus minimizing time spent checking on other parts. Engine oil, transmission fluid, coolant, windshield washer fluid, are some of the examples of vehicle fluids that commonly leak. Since some of the vehicle fluids may appear similar in both colour and consistency, there is a real need for a drip identification mat which enables a user to collect the fluid and point out an approximate location from where the leakage comes from.

In these respects, the fluid drip identification mat according to the present invention substantially departs from the conventional concepts and designs of the prior art, and in so doing provides a device primarily developed for the purpose of collecting drips from vehicular fluids and, at the same time, identifies the approximate location of the fluid leak, thus suggesting which vehicle parts the fluid leakage originates.

### SUMMARY OF THE INVENTION

In view of the foregoing disadvantages inherent in the known types of drip identification mats now present in the prior art, the present invention provides a new vehicle fluid drip identification mat construction wherein the drip identification mat can be utilized for collecting drips from vehicular fluids and, at the same time, identifying the approximate location of the vehicle part from which the fluid leakage originates.

The general purpose of the present invention, which will be described subsequently in greater detail, is to provide a new vehicle fluid drip identification mat designed to identify the location of fluid leakage relative to the position of the various vehicle parts, and thus enables a user to identify the source of leakage. The drip identification mat of the present invention is comprised of an oil-resistant rubber or cardboard mat placed underneath the vehicle. The drip identification mat is visually divided into sections corresponding to the various vehicle parts. When in use, the vehicle is parked atop the drip identification mat provided with the visual sections drawn on the mat which correspond to the approximate locations of the different vehicle parts. For example, a section for engine oil drawn on the mat will collect engine oil dripping from the engine block located above the drip identification mat.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new fluid drip identification mat which has many of the advantages of the drip identification mat mentioned heretofore and many novel features that result in a new drip identification mat which is not anticipated, rendered obvious, suggested, or even implied by any of the prior art drip catching devices, either alone or in any combination thereof.

It is another object of the present invention to provide a new drip identification mat which may be easily and efficiently manufactured and marketed.

It is a further object of the present invention to provide a new drip identification mat which is of a durable and reliable construction.

An even further object of the present invention is to provide a new drip identification mat which is susceptible of a low cost of manufacture with regard to both materials and labor, and which accordingly is then susceptible of low prices of sale to the consuming public, thereby making such drip identification mat economically available to the buying public.

Still yet another object of the present invention is to provide a new drip identification mat which provides in the apparatuses and methods of the prior art some of the advantages thereof, while simultaneously overcoming some of the disadvantages normally associated therewith.

Still another object of the present invention is to provide a new drip identification mat for collecting drips from vehicular fluids and provide quick and easy means for a user to identify the source of the vehicular fluid leakage and the approximate location of the leak relative to the parked vehicle.

According to one aspect of the present invention, it provides a vehicle fluid drip identification mat comprised of a base member having a front-end and a rear-end; a plurality of fluid identification sections, wherein each of the sections receives leaking fluid from a specific vehicle part; and a vehicle-parking guide means disposed near the front-end of the base member. The dimension of the mat corresponds approximately to the dimension of the vehicle itself.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a top schematic view of the drip identification mat of the invention;

FIG. 2 is an enlarged perspective view showing the drip identification mat resting on top of the rubber bump-parking guide in alignment with the bump-positioning marker;

FIG. 3a shows a reflector rod used as a parking guide being mounted to the front-end of the drip identification mat thereon;

FIG. 3b shows the reflector rod acting as a vehicle-parking guide;

FIG. 4 shows a top schematic view of a pair of parking markers used as a parking guide;

### DETAILED DESCRIPTION OF THE PREFERRED EMBODIMENT

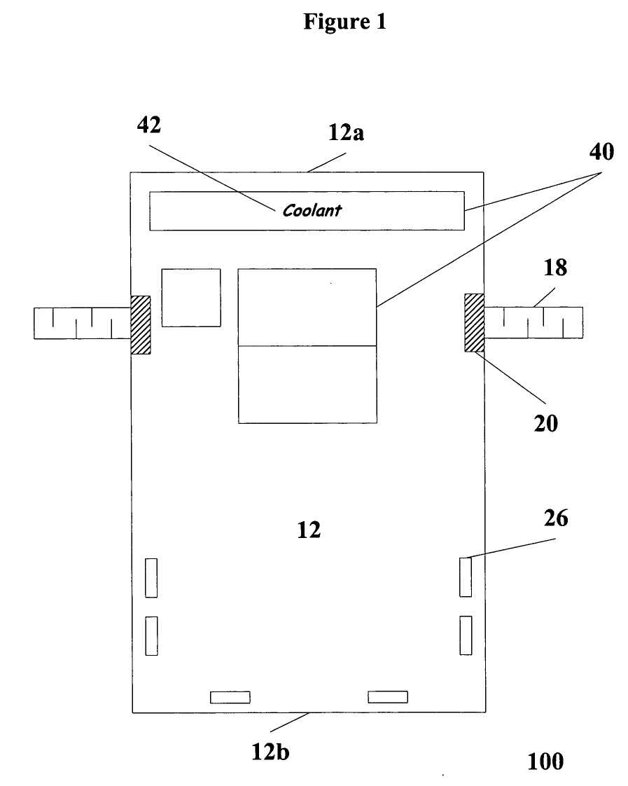

With reference now to the drawings, and in particular to FIGS. 1 through 4 thereof, a new drip identification mat embodying the principles and concepts of the present invention and generally designated by the reference numeral 100 will be described.

As best illustrated in FIGS. 1 through 4, the fluid drip identification mat 100 of the present invention is comprised of a base member 12 which corresponds to the general dimension of the vehicle 50, i.e., the length of the base member 12 is approximately the same as the length of the vehicle 50, and the width of the base member 12 also approximates that of the vehicle 50. The base member 12 is provided with a front-end 12a and a rear-end 12b. Front-end 12a corresponds with the front engine portion of vehicle 50, and vice versa.

As shown in FIG. 1, a plurality of vehicular fluid identification sections 40 are provided on the base member 12. The precise positions of these sections 40 are vital to the proper functioning of the drip identification mat 100. Each fluid identification section 40 is designed to collect vehicular fluid drip from a specific part of the vehicle. In FIG. 1, five fluid identification sections 40 are shown, namely a section for radiator coolant, windshield washer, engine oil, transmission fluid and break fluid. In order to assist the users, clear fluid markings 42 are either molded or printed on the relevant sections 40 on the surface of the base member 12.

Since the positions of vehicle parts differ from car model to car model, the fluid drip identification mat of the present invention is designed to be car model specific—that the drip identification mat for car model A manufactured by X is different from another drip identification mat for car model B manufactured by Y. By designing model-specific drip identification mat, the user is assured of the precise position of the vehicle parts located above the corresponding fluid identification sections 40 when the vehicle is properly parked on the drip identification mat 100.

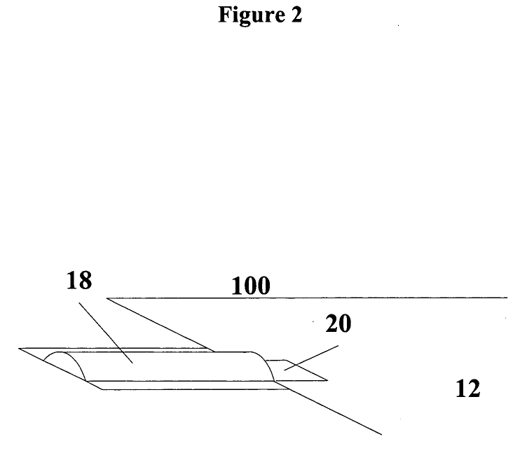

In order to ensure accurate identification of type of fluid leakage, relatively precise parking position of the vehicle is required. The present invention provides for various types of vehicle-parking guide means. These guide means may be used alone, or in combination. FIGS. 1 and 2 show a preferred vehicle-parking guide mean of the present invention. A pair of rubber bump 18 is disposed near the front-end 12a of the drip identification mat 100. Corresponding pair of bump markers 20 are imprinted on base member 12 such that a user can place the rubber bump 18 directly underneath the bump positioning marker 20 on each side of base member 12. Thus, bump positioning marker 20 acts as an alignment indicator for rubber bump 18. When parking the vehicle, a user proceeds forward until the wheels just go over the rubber bump 18. This signals the proper parking position of the vehicle. At this parked position, all fluid identification sections 40 on drip identification mat 100 correspond to the relatively precise positions of the vehicle parts whereby fluid leakage will likely to occur.

Optionally, instead of two rubber bumps 18—one on each side of the base member 12, the invention provides for a one-piece uniform rubber bump strip 18′ (not shown). To place bump 18′ underneath the drip identification mat 100, the user aligns rubber bump 18′ with the bump positioning marker 20 imprinted on the two sides of base member 12.

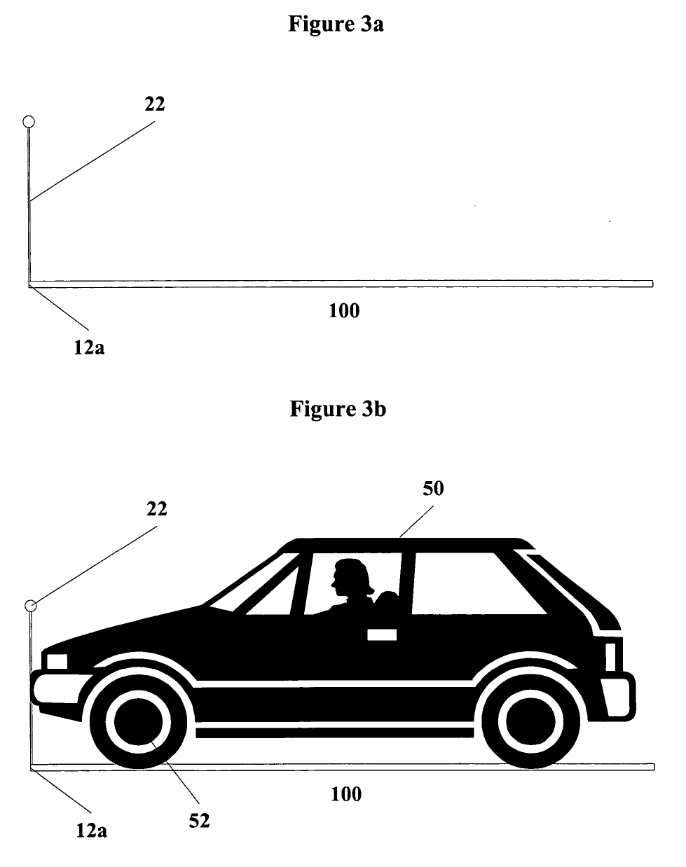

Two other types of vehicle-parking guide means 16 are contemplated and disclosed in the present invention. As shown in FIGS. 3a and 3b, a reflector rod 22 is mounted at or near the front-end 12a of base member 12. Reflector rod 22 can be mounted by conventional methods, such as by inserting the bottom of the rod into a corresponding recess on the base member 12. Since the drip identification mat 100 is tailor-made for a specific car model, parking a vehicle corresponding to the drip identification mat 100 with the front bumper of the vehicle barely touching the reflector rod 22 will assure correct parking position of the vehicle, such that all fluid identification sections 40 are receiving fluids from the corresponding vehicle parts.

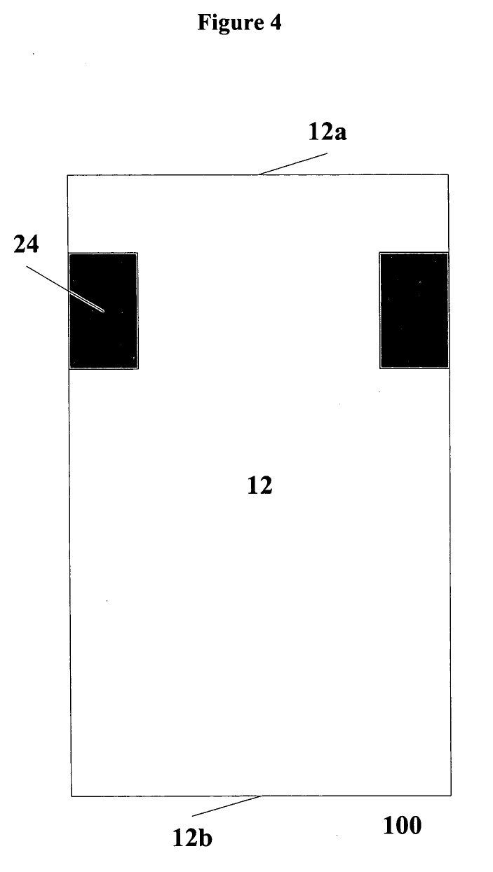

FIG. 4 illustrates another embodiment of a vehicle-parking guide means for the drip identification mat 100. The width of this mat is approximately 20% wider than the standard mat. One parking marker 24 is provided on each of the left and right sides along the edges of the drip identification mat 100, at a position near the front-end 12a of base member 12. The exact positions of the parking markers 24 are pre-determined by the car manufacturer for a specific car model and these markers correspond to the position of the wheels 52 when the vehicle is properly parked. At this position, all fluid identification sections 40 will correspond to the vehicle parts where fluid leakage may occur. A user drives over the drip identification mat 100 and slowly proceeds forward until he aligns the vehicle wheels 52 with the parking marker 24.

Optionally, the drip identification mat 100 can be provided with grids thereon to facilitate the ease of pinpointing and specifying the exact location of the fluid leak for the user to communicate the leak with a garage technician.

More optionally, a fluid identification section 40 designed to detect gasoline fuel leakage may be provided at the rear-end 12b of the base member 12. The exact location of the fluid identification section 40 is dictated by the location of the gas tank in a specific car model.

To facilitate handling and moving of the drip identification mat 100, a plurality of handles 26 are provided along the periphery of base member 12.

With respect to materials, the surface of base member 12 must be oil resistant and, preferably oil inert. In this regard, rubber or PVC is suitable material to be used. Alternatively, cardboards may be used which allows for lower manufacturing costs. However, the life span of drip identification mats made of cardboard will be substantially shorter.

In operation, a user parks the vehicle on top of the drip identification mat 100. Upon removing the vehicle after a period of time, if the user notices fluids are collected on one or more of the fluid identification sections 40, he can readily identify the source of the fluid leakage by noting the fluid marking 42 printed on the affected sections 40. Thereafter, the user can bring the vehicle to a garage and inform the service technician of the approximate leak relative to the vehicle. If the drip identification 100 is provided with the grids, the user can inform the technician the exact grid location of the fluid leakage. Sections on the drip identification mat 100 which have collected leaked fluids can be wiped dry and reused again.

Depending on car models, there may be situations whereby two or multiple vehicle parts are located one on top of the other. Consequently, there will be occasions whereby more than one type of fluids may be leaking into relatively the same fluid identification section 40 on the drip identification mat 100. With these types of car models, the drip identification mat 100 will provide a fluid identification section 40 on the base member 12 which indicates multiple fluids. If fluids are collected on such fluid identification section 40, all multiple vehicle parts should be checked for repair. For example, if engine oil and power steering are located one on top of the other in the engine compartment, and if power steering fluid is leaking, then the power steering fluid will be collected in fluid identification section 40 which indicates both “engine oil” and “power steering”. A service technician should then check both the engine oil and power steering for leaking.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A vehicle fluid drip identification mat comprising:
a base member having a front-end and a rear-end;
a plurality of fluid identification sections, wherein each of said sections receives leaking fluid from a specific vehicle part; and
a vehicle-parking guide means disposed near said front-end of said base member;
wherein dimension of said mat corresponds approximately to the dimension of said vehicle itself.

2. The vehicle fluid drip identification mat as claimed in claim 1, wherein said fluid identification sections are molded or printed with fluids markings corresponding to said specific vehicle parts where fluid leakages originate.

3. The vehicle fluid drip identification mat as claimed in claim 1, wherein said vehicle-parking guide means comprises a pair of rubber bumps placed underneath and aligned with a pair of corresponding bump-positioning markers disposed near the front-end on both sides of said base member.

4. The vehicle fluid drip identification mat as claimed in claim 1, wherein said vehicle-parking guide means comprises a one-piece uniform rubber bump strip placed underneath and aligned with a pair of bump-positioning markers disposed near the front-end on both sides of said base member.

5. The vehicle fluid drip identification mat as claimed in claim 1, wherein said vehicle-parking guide means comprises a reflector rod mounted at or near the front-end of said base member.

6. The vehicle fluid drip identification mat as claimed in claim 1, wherein said vehicle-parking guide means comprises a pair of parking markers provided on the left and right sides along the edges of said drip identification mat at a position pre-determined by a car manufacturer located near said front-end of said base member.

7. The vehicle fluid drip identification mat as claimed in claim 2, wherein said fluid identification sections provide for multiple fluids markings.

8. The vehicle fluid drip identification mat as claimed in claim 2, wherein said fluid identification sections are marked with grids for specifying the exact location of the fluid leakage.

9. The vehicle fluid drip identification mat as claimed in claim 1, wherein a plurality of handles are provided on said drip identification mat.

10. The vehicle fluid drip identification mat as claimed in claim 1, wherein said drip identification mat comprises rubber, PVC or cardboard

11. The vehicle fluid drip identification mat as claimed in claim 2, wherein said fluids markings comprise one or more of engine coolant, windshield fluid, engine oil, transmission, brake fluid and gasoline fuel.

12. The vehicle fluid drip identification mat as claimed in claim 7, wherein said fluids markings comprise one or more of engine coolant, windshield fluid, engine oil, transmission, brake fluid and gasoline fuel.
